(19) United States
(12) Patent Application Publication
(10) Pub. No.: US 2022/0156663 A1
(43) Pub. Date: May 19, 2022

(54) SYSTEMS, METHODS, AND USER INTERFACES FOR A WEB-BASED PERSONALIZED UPSKILLING PLATFORM INCLUDING SOLICITING, VALIDATING, AND PROVIDING DIGITAL ASSETS

(71) Applicant: PricewaterhouseCoopers LLP, New York, NY (US)

(72) Inventors: Suneet DUA, St. Petersburg, FL (US); Darren Terrence LEE, St. Petersburg, FL (US); Sanjay VERMA, Atherton, CA (US); Samant KUMAR, San Jose, CA (US)

(73) Assignee: PricewaterhouseCoopers LLP, New York, NY (US)

(21) Appl. No.: 17/525,654

(22) Filed: Nov. 12, 2021

Related U.S. Application Data
(60) Provisional application No. 63/113,950, filed on Nov. 15, 2020.
(60) Provisional application No. 63/166,770, filed on Mar. 26, 2021.

(51) Int. Cl. G06Q 10/06

(52) U.S. Cl. CPC G06Q 10/06315; G06Q 10/06398; G06Q 10/063112

(57) ABSTRACT

Systems, methods, and graphical user interfaces for soliciting, receiving, processing, and distributing digital assets amongst a plurality of users of an upskilling platform are provided. The system generates and stores a plurality of user profiles for a plurality of users of the system, wherein the user profiles indicate respective skill sets for the respective users. The system causes display of a graphical user interface configured to accept instructions regarding digital asset requests, and receives, via the graphical user interface, an input instructing a digital asset request and indicating one or more skills associated with the digital asset request. In response to receiving the input, the system determines a set users whose respective skill sets include the one or more skills associated with the digital asset request, and transmit, to respective user devices associated with the set of users, an indication of the digital asset request.

### RELATED APPLICATIONS

This application claims benefit to U.S. Provisional Application No. 63/113,950, filed Nov. 15, 2020, and to U.S. Provisional Application No. 63/166,770, filed Mar. 26, 2021, the entire contents of each of which are incorporated herein by reference.

### BACKGROUND

Digital assets may provide efficient solutions to problems that an organization desires to address, but managing the creation and exchange of digital assets can be a complex task. An organization member who identifies a need for a digital asset, for example, may not be best suited to create said digital asset to satisfy said need. Identifying organization members who are capable of creating a given digital asset may be extremely time consuming, particularly if the organization is large. Once the digital asset has been created, issues relating to the review, distribution, and implementation of the asset may arise if these processes occur across multiple platforms or ecosystems. For instance, it may beneficial for the asset to undergo a review wherein the functionality, costs, and/or benefits of the asset may be considered by qualified organization members. If the asset does address the initially identified need, organization leaders may wish the asset to be distributed and implemented by a plurality of organization members. Distributing the digital asset for review and/or use by the organization at large may allow the asset creator and/or the organization leaders to receive valuable feedback regarding the asset. According to known systems and methods, soliciting, creating, providing, validating, and distributing digital assets amongst user of organizations is organized and managed by manual processes. For example, users of systems may manually solicit assets, manually distribute assets, and manually selects sets of users to whom communications regarding digital asset creation should be sent.

### SUMMARY

As explained above, digital asset solicitation, creation, provision, validation, and distribution is organized and managed manually according to known methods. However, manual methods for organization, review, and communication can be time consuming and cost-ineffective for the organization. Accordingly, there is a need for improved systems and methods for solicitation, creation, provision, validation, and distribution of digital assets amongst members of organizations.

In particular, said improved methods should be efficient and should allow for intuitive use by various members of an organization having different roles. The methods and systems should allow, among other functionalities, for soliciting, validating, and providing digital assets to occur on a single platform. Organization leaders should be able to request and review digital assets in an organized manner, while creators of digital assets should be able to easily distribute their assets as well as receive feedback from leaders and peers. Moreover, the system should be configured such that automated decisions regarding communications of digital asset requests, digital asset submissions, and digital asset distributions are made. For example, the system should be able to automatically select sets of users to whom a communication should be sent, such that efficient and effective communications can be made amongst members of large organizations, without the need for optimal recipients to be manually selected by users.

In some embodiments, improved functionality for management of digital assets, as contemplated by the needs explained above, may be provided as a part of a web-based personalized upskilling platform. An upskilling platform may be usable by enterprises or by other large organizations to provide various functionalities in connection with skills of users of the system, including, for example, generating and visualizing insights regarding various organizations and users, and/or providing and managing consumption of upskilling content (e.g., media content objects such as videos, articles, quizzes, courses, etc.) to employees or other members of the organization. (While the disclosure herein provides examples in the context of organizations in which users are employees, upskilling platforms such as those described herein may be used by organization in which users are employees, members, subscribers, students, etc.) In some embodiments, an upskilling platform, such as those described herein, may be configured to automatically (e.g., periodically or in response to a trigger condition being satisfied) ingest data representing a plurality of organizations (e.g., companies, non-profit organizations, enterprises, educational institutions, etc.). The data may be ingested from a plurality of data sources including but not limited to, e.g., job listing data describing job openings and required/desired skills and experience for applicants for the particular role, job description data describing a current employee's role within an organization and/or the employee's skills and experience, and/or social media information in which an employee describes their role within an organization and/or skills and experience. In some embodiments, the system may also ingest data that is provided manually by a user (such as an administrator at an organization); for example, an organization may provide an organizational chart, employee roster, job information data, and/or employee information data.

The ingested data may be cleaned and formatted for storage in one or more databases of the system. In some embodiments, the data may be wholly or partially anonymized (or an anonymized version of the data may be created). In some embodiments, one or more automated algorithms (e.g., machine learning algorithms) may be applied to the ingested data in order to generate data to characterize an organization, a role within the organization, and/or one or more skills associated with a role within an organization.

In some embodiments, as explained herein, an upskilling platform may provide an ecosystem for the exchange of digital assets—e.g., automations, bots, or other digital solutions—that may be created by and/or shared amongst members of an organization. As explained herein, an upskilling platform may leverage information about skills (including skill types and skill levels) of specific users to make determinations as to sets of users to which a digital asset creation request, a digital asset validation request, and/or a created digital asset should be distributed. For example, a digital asset creation request may be distributed only to users whose skills and skill levels indicate they are suited to respond to the digital asset request. In some embodiments, following validation and/or distribution of a digital asset created by a user, the system may automatically upskill the user by providing a positive adjustment to one or more skill levels of the user to reflect the user's successful creation of the digital asset.

In some embodiments, an upskilling platform providing an ecosystem for digital asset management may include one or more graphical user interfaces that allow various users to interact with the system. For example, a graphical user interface provided to organization administrators may allow for administrators to create a request for a digital asset (e.g., an automation, a bot, other code, or other digital solutions), and the request may be transmitted to the user devices of one or more employees of the organization. The request may be presented to the one or more employees via the user interface rendered on the employee's device (e.g., computer, mobile electronic device, etc.), and the employees may use the graphical user interface to responsively create and/or upload a digital asset that is responsive to the request.

In some embodiments, the system may be configured to automatically determine which employees should be presented with the opportunity to fulfill the digital asset request. In some embodiments, the organization administrator may explicitly indicate one or more employees to whom the request should be forwarded. In some embodiments, the system may determine which employees should receive the request on the basis of employee skills and skill levels. For example, the administrator may indicate, or the system may algorithmically determine (e.g., based on the content of the digital asset request) which skills and/or skill levels are associated with the digital asset request, and the digital asset request may be automatically sent to employees meeting those skills and skill levels criteria.

In some embodiments, fulfillment of a digital asset request by an employee may cause one or more of the employee's skill levels to be updated. In some embodiments, the organization administrator may specify information regarding skill level increases that can be obtained by completing an asset request; in some embodiments, the system may automatically (e.g., algorithmically) determine what skill levels should be increased (and/or an amount by which they should be increased) in accordance with fulfilling an asset request.

In some embodiments, a graphical user interface rendered on an employee's device may include a visual indication of skill levels that will be improved (and/or an extent to which those skill levels will be improved) by completing an asset request. In some embodiments, the employee may be able to choose from among a plurality of asset request options that are presented as options via the graphical user interface.

In some embodiments, when a user uploads a digital asset responsive to a digital asset request, the digital asset may be presented to one or more other users of the system for review, modification, augmentation, comment, rating, sponsoring, liking, testing, approval, and/or other interaction. For example, other employees may be able to view the uploaded asset. In some embodiments, approved reviewers may be able to view and interact with the uploaded asset in order to test the asset or otherwise determine if it is a satisfactory response to the asset request. In some embodiments, the platform may provide a graphical user interface for an asset review and approval pipeline by which reviewers are able to perform a digital asset intake check, perform a digital asset quality check, and/or perform a digital asset level of service review. In some embodiments, assets that are approved by reviewers may then subsequently be distributed to a wider user base, such as to other employees for further interaction and/or for use of the digital asset.

In some embodiments, after an employee successfully completes a digital asset request, the system may update the employee's profile to indicate completion of the digital asset request and to adjust any skill levels in accordance with completion of the digital asset request. Additionally, the system may update one or more asset requests that are available to the employee. For example, by increasing skill levels and/or completing certain asset requests, the employee may “unlock” or progress to new asset requests that were previously unavailable to them. In some embodiments, progressing to new asset requests may occur in accordance with updates to an employee's current skill levels; in some embodiments, progressing may occur in accordance with the employee progressing through a predefined track of sequentially organized asset requests.

In some embodiments, the platform may provide functionality for an employee to upload an idea or a challenge (a challenge may include a solicitation for ideas) to the system, such that administrators and/or other employees may view and interact with the idea or challenge, such as by modification, augmentation, comment, rating, sponsoring, liking, testing, approval, or other interaction. In some embodiments, an idea or challenge submitted by an employee may be distributed to one or more users as (or including) a digital asset request, for example in accordance with the above.

In some embodiments, a system for transmitting digital assets amongst a plurality of users is provided, the system comprising one or more processors configured to cause the system to: generate and store a plurality of user profiles for a plurality of users of the system, wherein the user profiles indicate respective skill sets for the respective users; cause display of a graphical user interface configured to accept instructions regarding digital asset requests, receive, via the graphical user interface, a first input instructing a digital asset request and indicating one or more skills associated with the digital asset request; and in response to receiving the first input: determine a set users of the plurality of users of the system whose respective skill sets include the one or more skills associated with the digital asset request; and transmit, to respective user devices associated with the set of users, an indication of the digital asset request.

In some embodiments of the system, the digital asset comprises executable program code.

In some embodiments of the system, the indication of the digital asset request indicates a plurality of requirements for fulfilling the digital asset request and indicates the one or more skills associated with the digital asset request.

In some embodiments of the system, the input indicating the one or more skills associated with the digital asset request indicates: a preexisting skill of a user that is required for the user to be able to respond to the request; and an amount by which a skill level associated with the preexisting skill will be increased by for a user who fulfills the digital asset request.

In some embodiments of the system, the one or more processors are further configured to cause the system to: receive, from a first user of the set of users, a digital asset responsive to the digital asset request; in accordance with receipt of the digital asset, update a user profile of the first user to update the skill level for the first user.

In some embodiments of the system, the one or more processors are further configured to cause the system to transmit the digital asset to a set of users of the system different from the first user.

In some embodiments of the system, the one or more processors are further configured to cause the system to receive digital asset feedback for the digital asset from one or more of the set of users of the system, wherein the digital asset feedback comprises one or more feedback types selected from: a modified version of the digital asset, an expansion of the digital asset, a sponsorship of the digital asset, a comment on the digital asset, and a like of the digital asset.

In some embodiments of the system, the system is configured to cause display of a pipeline interface for interacting with digital assets that have been uploaded by users, wherein the pipeline interface provides interface screens for one or more of: a digital asset dashboard, a digital asset intake check, a digital asset quality check, a digital asset level of service review, and available digital assets.

In some embodiments, a method for transmitting digital assets amongst a plurality of users is provided, the method performed at a system comprising one or more processors, the method comprising: generating and store a plurality of user profiles for a plurality of users of the system, wherein the user profiles indicate respective skill sets for the respective users; causing display of a graphical user interface configured to accept instructions regarding digital asset requests, receiving, via the graphical user interface, a first input instructing a digital asset request and indicating one or more skills associated with the digital asset request; and in response to receiving the first input: determining a set users of the plurality of users of the system whose respective skill sets include the one or more skills associated with the digital asset request; and transmitting, to respective user devices associated with the set of users, an indication of the digital asset request.

In some embodiments, non-transitory computer-readable medium storing instructions for transmitting digital assets amongst a plurality of users is provided, wherein the instructions are executable by a system comprising one or more processors to cause the system to: generate and store a plurality of user profiles for a plurality of users of the system, wherein the user profiles indicate respective skill sets for the respective users; cause display of a graphical user interface configured to accept instructions regarding digital asset requests, receive, via the graphical user interface, a first input instructing a digital asset request and indicating one or more skills associated with the digital asset request; and in response to receiving the first input: determine a set users of the plurality of users of the system whose respective skill sets include the one or more skills associated with the digital asset request; and transmit, to respective user devices associated with the set of users, an indication of the digital asset request.

In some embodiments, any of the above systems, methods, and computer-readable storage media may be combined, in whole or in part, with one another, and/or with any other features disclosed herein.

### BRIEF DESCRIPTION OF THE DRAWINGS

FIG. 1 shows a system providing a personalized web-based upskilling and digital asset management platform, according to some embodiments.

FIG. 2 shows a method for soliciting, validating, and providing a digital asset, according to some embodiments.

FIG. 3 shows a method for requesting receiving a request for a digital asset, according to some embodiments.

FIG. 4 shows a graphical user interface screen for receiving a digital asset request, according to some embodiments.

FIG. 5 shows a method for receiving submission of a digital asset, according to some embodiments.

FIG. 6 shows a graphical user interface screen for receiving a digital asset submission, according to some embodiments.

FIG. 7 shows a method for validating a digital asset submission, according to some embodiments.

FIG. 8 shows a graphical user interface screen for validating a digital asset submission, according to some embodiments.

FIG. 9 shows a computer, in accordance with some embodiments.

### DETAILED DESCRIPTION

Reference will now be made in detail to various embodiments, examples of which are illustrated in the accompanying drawings. Wherever possible, the same reference numbers will be used throughout the drawings to refer to the same or like parts. Moreover, use of the indefinite article “a” or “an” in the specification and the claims is meant to include one or more of the feature that it introduces, unless otherwise indicated.

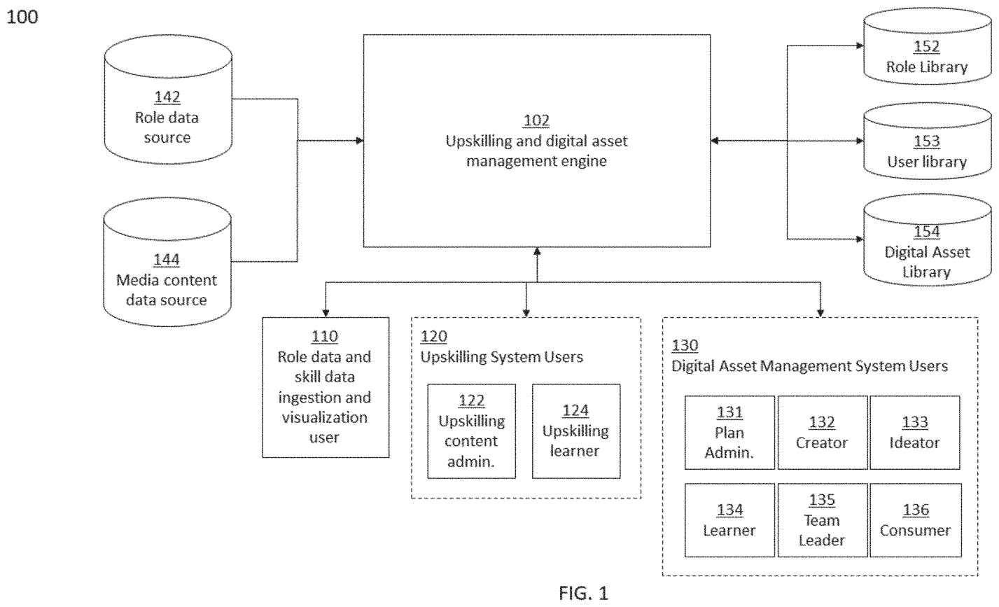

FIG. 1 shows a system 100 providing a personalized web-based upskilling and digital asset management platform, according to some embodiments. As shown, system 100 comprises a central upskilling and digital asset management engine 102 configured to communicate (e.g., via wired or wireless electronic communication) with a plurality of user devices, data sources, and libraries. Upskilling and digital asset management engine 102 may comprise one or more processors. Users of system 100 may include a role data and skill data ingestion and visualization user 110, upskilling system users 120, and digital asset management system users 130. Data sources include role data source 143 and media content data source 144. Libraries include role library 152, user library 153, and digital asset library 154.

As described herein, various users of system 100 may be associated with different roles, different permissions, and/or different associated graphical user interface screens. Furthermore, users may be associated with user-specific profiles (e.g., stored information associate with the user) that indicates the user's role, the user's permissions, and/or the user's skills and skill levels. The users depicted in FIG. 1 are exemplary, and in some embodiments system 100 may include additional users of other user types/roles. In some embodiments, a single user may interact with system 100 in more than one of the user roles/types contemplated by FIG. 1. As shown in FIG. 1, users of system 100 may include:
Role data and skill data ingestion and visualization user 110, who may interact with one or more user interface screens configured to allow the user to control ingestion of role data and skill data and to generate one or more visualizations representing roles within an organization, skills of members of an organization, skills of certain role types, skills of specific users/employees, comparisons of different organizations, and/or comparisons of different users;
Upskilling content administrator 122, who may interact with one or more user interface screens configured to allow the user to manage creation and/or modification of user profiles for upskilling learners (e.g., profiles for employees who will consume upskilling media content), creation and/or modification of role profiles, ingestion of upskilling media content, and/or creation of data associating upskilling media content with one or more role profiles and/or one or more user profiles;
Upskilling learner 124, who may interact with one or more user interface screens configured to allow the user to consume upskilling content (e.g., upskilling media content) in order to obtain additional skills and/or to increase skill levels for existing skills;
Plan administrator 131, who may interact with one or more user interface screens configured to allow the user to review digital asset submissions, determine one or more users to whom digital assets and/or upskilling content are submitted, and/or determine a manner in which one or more digital assets and/or upskilling content are distributed amongst users;
Creator 132, who may interact with one or more user interface screens configured to allow the user to create and upload a digital asset submission, optionally including digital asset code and associated metadata;
Ideator 133, who may interact with one or more user interface screens configured to allow the user to create and upload a digital asset solicitation (e.g., an “idea”);
Learner 134, who may interact with one or more user interface screens configured to allow the user to consume upskilling content (e.g., upskilling media content) and/or digital assets in order to obtain additional skills and/or to increase skill levels for existing skills;
Team leader 135, who may interact with one or more user interface screens configured to allow the user to review digital asset submissions, determine one or more users to whom digital assets and/or upskilling content are submitted, and/or determine a manner in which one or more digital assets and/or upskilling content are distributed amongst users; and
Consumer 136, who may interact with one or more user interface screens configured to allow the user to view, review, implement, test, rate, “like,” and/or submit feedback for one or more digital assets.

Upskilling and digital asset management engine 102 may communicate with the plurality of users by transferring data to and/or receiving data from a plurality of user devices belonging to said plurality of users. In some embodiments, user devices may include desktop computers, laptops, smart phones, and/or tablets. In some embodiments, upskilling and digital asset management engine 102 may cause one or more graphical user interface (GUI) screens to display on the display of a user device. Depending on the user, the one or more GUI screens may be configured to display information and/or receive user input related to role data ingestion and visualization, skill data ingestion and visualization, upskilling, and/or digital asset management.

In some embodiments, upskilling and digital asset management engine 102 may receive data representing a plurality of organizations. Organizations may include companies, non-profit organizations, enterprises, educational institutions, and the like. Upskilling and digital asset management engine 102 may ingest data representing roles (e.g., employee positions) within an organization from role data source 142. In some embodiments, role data source 142 may include one or more data sources for job listings and/or job descriptions, such as company websites, social media and/or professional networking websites (e.g., LinkedIn) and/or such as job listing websites. Role data received from role data source 142 may include job listing data describing job openings and required/desired skills and experience for applicants for the particular role, job description data describing a current employee's role within an organization and/or the employee's skills and experience, social media information in which an employee describes their role within an organization and/or skills and experience, organizational charts for one or more organizations, employee rosters for one or more organizations, job information data relating to one or more organizations, and/or employee information data relating to one or more organizations.

In some embodiments, upskilling and digital asset management engine 102 may be configured to generate one or more role profiles based on role data received from role data source 142. A role profile may comprise data describing the required and/or desired skills and experience necessary to fulfill a corresponding role within an organization. In some embodiments, role profiles may be specifically configured for one organization (or a set of organizations); in some embodiments, role profiles may be configured generally for all organizations using system 100. Role profiles may be stored by system 100 in role library 152, which may include and/or provide any suitable electronic storage systems (e.g., databases).

In some embodiments, in addition to role profiles stored in role library 152, system 100 may include user profiles stored in user library 153. While role profiles may indicate information regarding average (and/or optimal) skills and skill levels for a certain role type, a user profile may include user information—including role information, skill type information, and skill level information—for a specific user. Information stored regarding a specific user may include user identification information, the user's organization, the user's position within the organization's structure, one or more roles of the user within the organization, and an indication of what skills (and associated skill levels) the user possesses. In some embodiments, user profiles, role information for a user, and skill information for a user may be automatically ingested and/or extracted from one or more data sets provided to system 100, and/or may be explicitly indicated by one or more users of system 100 creating and/or configuring user profiles. Thus, upskilling and digital asset management engine 102 may have access to information regarding the current skills and skill levels of employees within an organization, as well as the target skills and skill levels for users having that role. One or more system operations may be carried out in accordance with skill gaps (e.g., skill deltas) representing a difference between a user's current skill levels and target skill levels for that user's role or roles.

Upskilling and digital asset management engine 102 may be configured to increase or decrease a skill level of a skill for an employee upon receipt of certain data (e.g., data indicating that an employee has consumed upskilling content, or indicating that a user has created, implemented, and/or consumed a digital asset). In some embodiments, users (e.g., organization administrators) of system 100 may manually review, approve, and/or modify skill levels and/or skill level adjustments for users.

Upskilling and digital asset management engine 102 may ingest data representing media content from media content data source 144. In some embodiments, media content may include upskilling content and may comprise articles, videos, essays, podcasts, quizzes, and/or interactive courses. In some embodiments, media content data source 144 may include one or more external sources of educational courses (e.g., a university website, a commercial educational content source, etc.), websites for hosting videos (e.g., YouTube), academic journals, magazines, newspapers, and/or social media sites (e.g., LinkedIn). In some embodiments, upskilling and digital asset management engine 102 may be configured to link role profiles with ingested media content related to the role. For example, engine 102 may generate metadata associating specific courses or other media content with a certain role profile, such that the indicated media content may serve as upskilling content for users of the indicated role. When users consume the indicated media content, engine 102 may then automatically cause the user's skill levels to increase by an amount indicated by metadata associated with the media content and/or with the role profile for the user's role. In some embodiments, upskilling and digital asset management engine 102 may transmit ingested media content data to digital asset library 154 for storage, optionally in association with metadata relating to upskilling via the indicated media content.

In some embodiments, system 100 may be configured to execute methods for soliciting, creating, providing, validating, and distributing digital assets. As described herein, said methods may be performed, in whole or in part, by a web-based upskilling system such as system 100. Upskilling and digital asset management engine 102 may receive a digital asset request from a user, e.g., one of the digital asset management system users 130, such as ideator 133. In some embodiments, the user providing the digital asset request may do so by executing one or more inputs via a graphical user interface screen displayed on a user device used by the user, such as a user device of ideator 133.

The request received by engine 102 may include various information about the digital asset being requested and about skill levels associated with the digital asset request. The digital asset request may comprise data related to a problem or a need to be addressed by the requested digital asset. Additionally, the digital asset request may comprise data related to one or more required skills (and, optionally, required skill levels for one or more required skills) which digital asset management system users 130 must have in order to see and/or respond to the digital asset request. In some embodiments, an indicated required skill may be mandatory or it may be suggested/encouraged. Furthermore, the digital asset request may include information regarding one or more skill level gains or increases to be received by a user who successfully fulfills the digital asset request.

In some embodiments, a user submitting a digital asset request, such as ideator 133, may be a member of a team comprising users of digital asset management system users 130. For example, when ideator 133 submits a digital asset request, upskilling and digital asset management engine 102 may transmit data notifying one or more other users. In some embodiments, a user of digital asset management system users 130 a user who leads the team, such as team leader 135, may be notified of the new digital asset request. In some embodiments, system 100 may provide one or more graphical user interface screens configured to allow team leader 135 to provide feedback regarding the digital asset request, including by allowing team leader to approve, reject, and/or modify the digital asset request. In some embodiments, team leader 135 may approve and/or modify the digital asset request before system 100 distributes the digital asset request to one or more other users.

Upskilling and digital asset management engine 102 may be configured to automatically (e.g., algorithmically) determine which users are qualified to fulfill the digital asset request. For example, engine 102 may compare information included in the digital asset request that specifies requires skills and/or skill levels for the request to information in one or more user profiles (for example stored in user library 153) to select users who possess the required skill prerequisites for responding to the request. In some embodiments, the system may select one or more users whose skills meet minimum sufficiency requirements and who can benefit from potential upskilling of one or more skills if the request is successfully completed. In order to make these determinations, engine 102 may compare skill information indicated in the asset request, user skill information indicated in a user profile in user library 153, and/or role profile skill goal information indicated in a role profile in role library 152. Upon determining one or more qualified users, upskilling and digital asset management engine 102 may transmit the digital asset request to the qualified users. In some embodiments, upskilling and digital asset management engine 102 may cause a GUI screen comprising information related to the digital asset request to display on the qualified users' user devices.

Following publication of the digital asset request to one or more selected users, the system may receive submission of a digital asset responsive to the request. For example, engine 102 may receive a digital asset submission from a user, such as creator 132. The digital asset submission may include data (e.g., one or more files) representing the digital asset itself, along with metadata regarding the digital asset and/or the digital asset submission. For example, the digital asset submission may include code constituting one or more automations constituting the digital asset. The digital asset submission may additionally include information indicating a digital asset type (e.g., automation, bot, etc.), information indicating functionality for the digital asset, information regarding the user or users who created the digital asset, and/or version information for the digital asset. In some embodiments, a user, such as creator 132, may create and/or upload the digital asset (and may indicate metadata associated with the digital asset) by executing one or more inputs via a graphical user interface screen displayed on a user device.

Upon receiving the digital asset submission, engine 102 may provide for review, validation, rejection, approval, and/or modification of the digital asset by one or more reviewer users. For example, engine 102 may transmit the digital asset (and, optionally, associated metadata) to a reviewer, such as plan administrator 131. Plan administrator 131 may review the digital asset to determine whether the digital asset meets one or more validation/approval requirements, for example as specified by the digital asset request originally submitted to the system. Engine 102 may receive user input from the reviewing user indicating whether the asset should be approved, rejected, and/or modified. In addition, engine 102 may apply one or more automated evaluation procedures (e.g., validation procedures) to the submitted digital asset in order to determine whether it meets one or more criterial for approval. For example, engine 102 may cause a graphical user interface screen to be displayed, on user devices belonging to one or more digital asset management system users 130, wherein the graphical user interface screen allows a user to review the digital asset, test the digital asset, and/or execute one or more inputs that indicate approval, modification, and/or rejection of the digital asset. If the user input (and/or automated review) indicates approval of the digital asset, then engine 102 may cause the digital asset to become accessible to one or more additional users of system 100, for example by publishing the digital asset to said users. In some embodiments, information regarding the review, approval, or rejection of a digital asset may be stored, in association with the digital asset, in digital asset library 154 for storage.

In some embodiments, upon determining that the submitted digital asset is approved (and, optionally, published), system 100 may execute one or more upskilling operations in accordance with approval of the digital asset. For example, one or more skills and/or skill levels of the user who submitted the digital asset (and/or users who tested, reviewed, and/or approved the digital asset) may be updated to reflect the user's role in creation, review, and/or approval of the digital asset. In some embodiments, engine 102 may access a user profile corresponding to the user who submitted the digital asset (e.g., creator 132), which may be stored in user library 132, and may update skill data associated with the user profile, for example by adding on or more new skills and/or by increasing a skill level for one or more existing skills. In some embodiments, the adjustments made to a user's skills may be automatically determined in accordance with information indicated in the digital asset request, and/or in accordance with upskilling feedback information indicated by a reviewer (e.g., plan admin 131) who reviewed the submitted digital asset. Engine 102 may update the skill data automatically in response to the digital asset being approved and/or published, or may update the skill data in response to an instruction to do so received from one or more users (e.g., plan administrator 131 or team leader 135).

In some embodiments, one or more system users may view, download, review, use, or otherwise implement the approved and published digital asset. For example, a user, such as consumer 136, may receive the published digital asset. In some embodiments, the user may provide feedback for the received digital asset, for example by executing input via a graphical user interface screen. The user may execute input to comment on, “like,” bookmark, review, or save the digital asset. Information regarding said user feedback may be stored, for example in digital asset library 154, in association with the digital asset.

In some embodiments, an approved and published digital asset may be consumed by a user of system 100 as part of an instructional plan and/or an upskilling plan. For example, a digital asset may be transferred to a user such that the asset can be reviewed, implemented, consumed, tested, and/or modified by the user as part of the user's participation in a course or other instructional plan. In some embodiments, a course or instructional plan may be configured by a user such as plan administrator 131 and/or team leader 135, who may execute one or more user inputs to designate a digital asset as a part of the course or instructional plan. A user completing the course or instructional plan, such as learner 134, may then review, implement, consume, test, and/or modify the digital asset as the user participates in the course or instructional plan. Engine 102 may, for example, automatically transmit the digital asset to learner 134 in response to learner 134 executing a user input selecting the course or instructional plan. In some embodiments, one or more skills associated with a user profile for a user completing a course or instructional plan may be adjusted by engine 102 in response to the user's completion of all or part of the course or instructional plan, including for example the user's completion of review or implementation of the digital asset included therein.

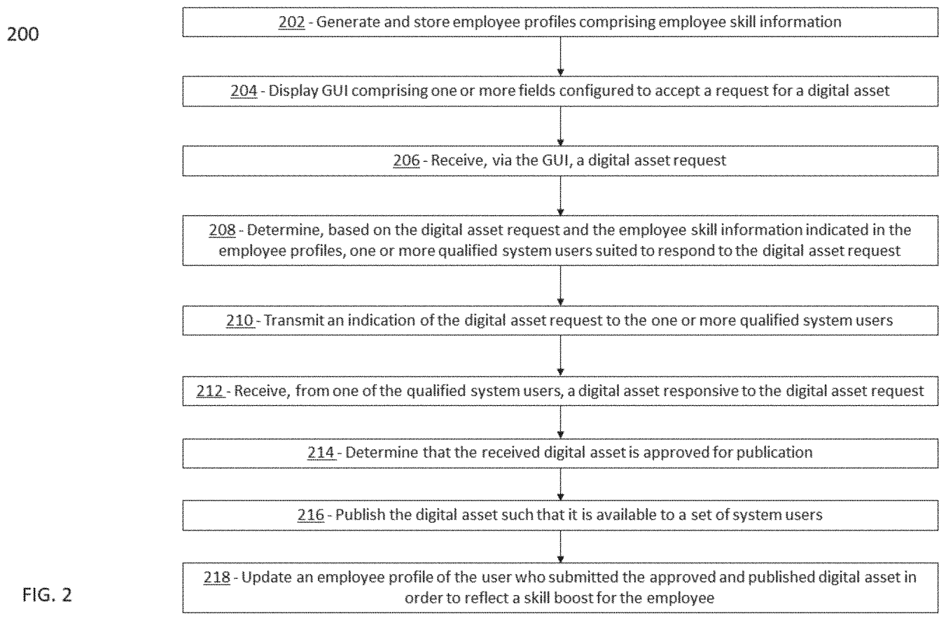

FIG. 2 shows a method 200 for soliciting, validating, and providing a digital asset, according to some embodiments. Method 200 may be executed by one or more processors included in a system for upskilling and digital asset management, for example by system 100 described above with reference to FIG. 1.

In some embodiments, at block 202, the system may generate and store one or more employee profiles comprising employee skill information are generated and stored. In some embodiments, an employee profile may share any one or more characteristics in common with a user profile described above with reference to FIG. 1. The employee profile may include, for example, information indicating a role for the employee, target skills and/or skill levels for the employee, and/or current skills and/or skill levels for the employee.

Employee profiles may be generated automatically based on information regarding an organization's workforce, for example information important from a human resources database and/or from a company website. In some embodiments, employee profiles may be generated, in whole or in part, based on one or more user inputs provided by a user. For example, a user may execute one or more inputs via a graphical user interface, wherein the inputs may indicate current skill information and/or target skill information for a user profile. In some embodiments, target skill information for a user profile may be automatically determined by the system based on a role profile for a role indicated by the user profile. In the example of system 100, the employee profiles may be stored in a database of user profiles, such as user library 153.

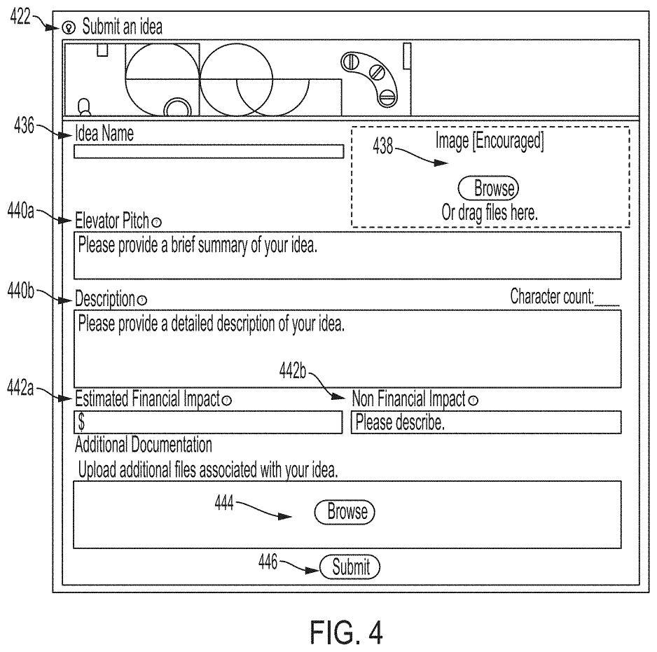

At block 204, the system may cause display of a graphical user interface comprising one or more fields configured to accept a request for a digital asset. For example, a GUI screen comprising one or more fields configured to accept a request for a digital asset may be displayed on one or more user devices belonging to one or more users the system, such as one or more of users 130 in system 100. In some embodiments, the graphical user interface screen displayed may share any one or more characteristics in common with graphical user interface screen 400 described below with reference to FIG. 4. The GUI screen may include one or more fields (and/or one or more other graphical user interface objects or affordances) configured to accept user inputs indicating identity information (e.g., a name) for a digital asset request, description information for a digital asset request, requirement information for a digital asset request (e.g., one or more criteria with which a digital asset that satisfies the request must comply), and/or skill information for the digital asset request (e.g., indicating one or more prerequisite skills for response to the digital asset request and/or one or more skills that may be upskilled by completing the digital asset request).

At block 206, in some embodiments, a digital asset request is received, via the GUI, from one of the user devices on which the GUI is displayed. For example, a user may execute one or more inputs specifying any of the digital asset request information described above, and the system may cause transmission of the information from the user device to a central system, e.g., engine 102. In the example of system 100, the user who submits the digital asset request may have one or more characteristics as described above with reference to ideator 133.

At block 208, the system may determine, based on the digital asset request and based on employee skill information indicated in the employee profiles, one or more users who are qualified to respond to the digital asset request. In some embodiments, the system may select all users (or a subset of users) for whom skills and/or skill levels indicated in the associated user profile meet criteria specified by the digital asset request.

In some embodiments, the skill criteria may include criteria for skills possessed by a user, for skill levels for one or more specific skills possessed by a user, and/or for skill gaps between a current skill level of a user and a target skill level of a user for that user's role. Regarding selecting users based on skill gaps, the system may, in some embodiments, select users who can achieve a desired upskilling (e.g., a desired improvement of a current skill level in working toward a target skill level for that user's role) by fulfilling the digital asset request. In some embodiments, a user who meets minimum skill-level criteria and who can achieve upskilling may be selected by the system in favor of (e.g., instead of) another user who also meets the minimum skill threshold but who would not achieve a desired upskilling by responding to the digital asset request (e.g., because the user does not need to increase a certain skill level to achieve a target skill level for his role, and/or because the user has already maximized a certain skill level that could otherwise be increased by responding to the digital asset request).

In some embodiments, skill criteria may be explicitly specified in the digital asset request, such as by being explicitly indicated by the user who submits the request. In some embodiments, the system may automatically (e.g., algorithmically) determine one or more skill criteria for a digital asset request based on other information about the request. For example, analysis of the content of the request itself, such as applying natural language understanding and/or machine learning to the text or other content of the digital asset request, may be used to automatically determine one or more skill criteria for the digital asset request. In some embodiments, skill criteria may be determined by selecting skill criteria that are the same or similar as skill criteria for one or more other digital asset requests that share one or more characteristics in common with the instant request. In some embodiments, skill criteria may be determined by selecting skill criteria based on skills that are possessed by users who have successfully fulfilled one or more other digital asset requests that share one or more characteristics in common with the instant request.

In some embodiments, selection of one or more users to potentially response to the digital asset request may be based on additional consideration beyond which users are qualified to do so based on skill criteria. For example, selection of one or more user may additionally be based on a specific role indicated in the digital asset request, a specific group or set of users indicated in the digital asset request, and/or a specific user indicated in the digital asset request.

At block 210, in some embodiments, the system may transmit an indication of the digital asset request to the one or more selected qualified system users. That is, after the one or more qualified users (and/or one or more users selected on one or more additional criteria in addition to skill-based qualifications) have been identified by the system, an indication of the digital asset request may be transferred to the one or more selected users. The system may cause information regarding the digital asset request to be displayed on a graphical user interface screen displayed on a device of a selected user; for example, an indication of the digital asset request may be displayed as an item in a mailbox of the user, and/or it may be displayed on a menu of available/outstanding digital asset requests that may be viewed by the user.

At block 212, a digital asset responsive to the digital asset request is received from one of the selected (e.g., qualified) system users. In the example of system 100, creator 132 may upload a digital asset, to engine 102, responsive to the digital asset request. In some embodiments, a user may upload the digital asset itself optionally along with metadata including, for example, information describing one or more characteristics of the digital asset, the creator, and/or the submission. In some embodiments, a user submitting a digital asset responsive to a request may input information describing the digital asset via a graphical user interface screen displayed on the user's device, for example by entering information into one or more displayed fields and/or by selecting one or more options from one or more displayed menus. In some embodiments, a user submitting a digital asset responsive to a request may attach a file including code that forms all or part of the digital asset itself. Upon receiving a submitted digital asset, the system may store the digital asset (along with any associated metadata) in one or more suitable electronic storage mediums, such as by storing it in digital asset library 154 of system 100.

At block 214, in some embodiments, the system may determine that the digital asset is approved for publication. Determination of approval may improve subjecting the digital asset to one or more manual and/or automated review procedures to determine whether approval criteria are satisfied.

Determination of approval may involve transmitting the received digital asset to one or more qualified users (e.g., plan administrator 131 in system 100) for review by said user. Information about the digital asset may be displayed on a user interface of the reviewing user's device. The reviewing user may have the opportunity to execute the digital asset and to view information regarding its execution in a graphical user interface displayed on the reviewing user's device. The reviewing user may have the ability to enter input into a displayed graphical user interface indicating approval, rejection, feedback, and/or modifications (to be made automatically or to be transmitted for suggestion/consideration) for the digital asset. Information regarding the outcome of an automated and/or manual review of the submitted digital asset may be stored by the system in association with the digital asset, for example by being stored in digital asset library 154 of system 100.

At block 216, in some embodiments, the digital asset may be published such that it is available to a set of system users. Publication of the digital asset may be performed automatically in response to the asset being approved, and/or it may be performed in response to a manual instruction executed by a user, such as an administrator and/or a user reviewing the submitted digital asset. In some embodiments, the digital asset may be made available—for example by being presented to users via one or more graphical user interface menus—to all system users. In some embodiments, the digital asset may be made available only to a selected set of users, wherein the set of users to whom the asset is published may be determined based on input in the digital asset request, based on input in the digital asset submission, based on input from the digital asset reviewer/approver, based on roles of the set of users to whom the asset is published, and/or based on an overlap between one or more skills associated with the digital asset and skills of the set of users to whom the asset is published.

At block 218, in some embodiments, an employee profile of the user who submitted the approved and published digital asset may be updated to reflect a skill boost for the user. A skill boost may include an addition of one or more new skills and/or an increase in skill level(s) of one or more existing skills. The amount by which one or more skill levels of the user are increased may be determined manually by an administrator and/or by a reviewer who approved the digital asset for publication. The amount by which one or more skill levels of the user are increased may, alternatively or additionally, be determined algorithmically by the system (e.g., by engine 102) based on automated analysis of code of the digital asset, based on a quality score assigned to the digital asset (either manually or automatically), based on information in the digital asset request or indicated in the review indicating an importance level and/or a complexity level of the digital asset (e.g., more complex requests may grant larger skill boosts), and/or based on an extent of distribution/adoption of the approved digital asset (e.g., widely distributed and/or widely adopted digital assets may grant larger skill boosts). In the example of system 100, the user profile of the user that submitted the digital asset may be updated to reflect a skill increase by saving a new skill level (and/or a new skill) to the user's profile in user library 153.

In some embodiments, in addition to the skill boost for the user who submitted the digital asset, one or more skill boosts may also be applied to other users involved in the digital asset solicitation, review, approval, and distribution process. For example, a skill boost may be granted to a user who solicited, reviewed, modified, approved, commented, tested, and/or facilitated distribution of a digital asset.

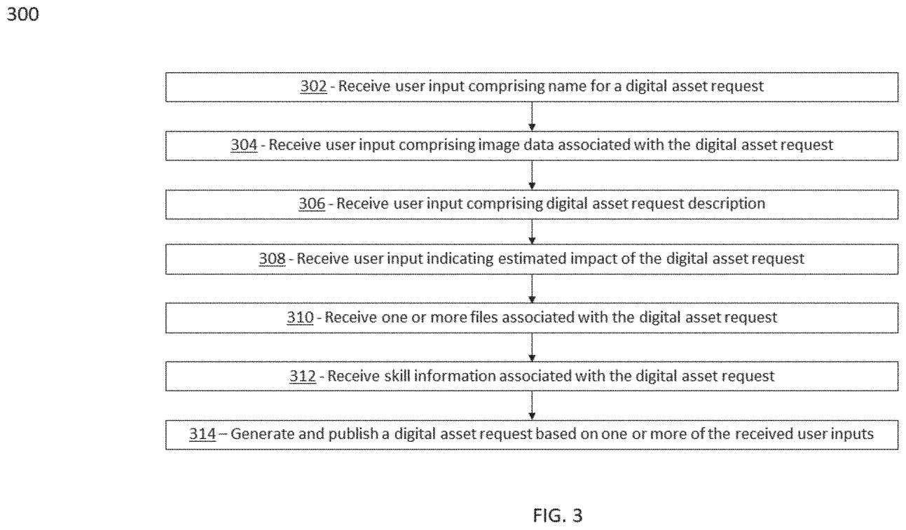

FIG. 3 shows a method 300 for receiving a request for a digital asset, according to some embodiments. Method 300 may be executed by one or more processors included in a system (e.g., system 100 of FIG. 1) for upskilling and digital asset management. In some embodiments, all or part of method 300 may be performed as a part of method 200 (e.g., block 206 of method 200). As described below, method 300 may include receipt, by a system (e.g., system 100) of a plurality of user inputs indicating various information about a digital asset request. In some embodiments, any one or more of the various inputs described with reference to method 300 may be executed by a user of a graphical user interface provided by an upskilling and digital asset management system. For example, a user (e.g., ideator 133) of a user device may execute one or more of the inputs of method 300 by entering information into fields of a graphical user interface and/or selecting one or more options using graphical user interface menus or affordances.

At block 302, in some embodiments, a system may receive a user input comprising a name for a digital asset request. For example, a user of the system (e.g., ideator 133 of FIG. 1) may type a name for a digital asset request into a field of a graphical user interface configured to accept digital asset request information. In some embodiments, the input may be presented by the graphical user interface as a name for an “Idea” submitted by the user.

At block 304, in some embodiments, the system may receive a user input comprising image data associated with the digital asset request. For example, the user of the system may select one or more image files from a system library, upload one or more images from their user device, and/or capture one or more images using a camera of their device. In some embodiments, image data associated with the digital asset request may include images (e.g., diagrams, flowcharts, sketches, screenshots, etc.) describing or characterizing a problem to be addressed by the requested digital asset and/or methods or algorithms to be executed by the requested digital asset.

At block 306, in some embodiments, the system may receive a user input comprising a description of the digital asset request. For example, the user of the system may type a written description into a field of a graphical user interface configured to accept digital asset request information. In some embodiments, the description may comprise a written explanation of the problem to be addressed by the requested digital asset. In some embodiments, the description may include a description of digital asset type (e.g., automation, bot, etc.) that is being requested. In some embodiments, a user may provide a short-form description (e.g., an “elevator pitch”) and a long-form description; the graphical user interface may provide a higher character limit for accepting inputs for the latter.

At block 308, in some embodiments, the system may receive a user input comprising an indication of an impact (e.g., an estimated impact) of the requested digital asset. An estimated impact may include an estimate of a financial impact and/or an estimate of a non-financial impact. In some embodiments, a user may indicate an estimated impact by typing into a field and/or by selecting a menu option.

At block 310, in some embodiments, the system may receive a user input comprising one or more files associated with the digital asset request. In some embodiments, user input may include text files, image files, and/or video files comprising idea information. In some embodiments, user input may include files required for the requested asset to function (e.g., files containing code for running the requested digital asset).

At block 312, in some embodiments, the system may receive a user input comprising an indication of skill information for the digital asset request. Skill information may indicate one or more skills (optionally including skill levels) required of a user in order for said user to be able to see and/or respond to the digital asset request (e.g., this may be used by the system to select users to whom the digital asset request is published). In some embodiments, skill information may comprise information regarding skills that may be gained (and/or increased in skill level) by a user who successfully fulfills the digital asset request. In some embodiments, skill information may include information regarding an amount by which a skill levels may be increased. In some embodiments, skill information may include information specifying required or suggested skill levels for users who can implement the digital asset once the digital asset has been provided and distributed (e.g., this may be used by the system to select users to whom the resulting digital asset is published).

At block 314, in some embodiments, the system may generate a digital asset request based on one or more of the inputs received at blocks 302-312. Generating the digital asset request may comprise generating a data structure based on all or part of the data inputted at blocks 302-312, including optionally reformatting one or more of the received user inputs. The generated digital asset request may be stored and/or transmitted to one or more user devices of the system, for example by being published for display on graphical user interfaces of devices of system users who are eligible to potentially respond to the digital asset request

FIG. 4 shows a graphical user interface screen 422 for receiving a digital asset request, according to some embodiments. In some embodiments, GUI screen 422 may be used by a user of a system to execute all or part of method 300, or to otherwise execute one or more inputs for creating a digital asset request to be transmitted to one or more users of the system. As shown, GUI screen 422 comprises fields for receiving user input including a digital asset request name field 436, digital asset request description fields 440a and 440b, and estimated impact fields 442a and 442b. Digital asset request descriptions fields may include elevator pitch field 440a, wherein a user may input a concise description of their request, as well as a detailed description field 440b, wherein a user may input a more thorough description of their request. Estimated impact fields may include an estimated financial impact field 442a and an estimated non-financial impact field 440b. GUI screen 422 may comprise an image upload icon 438 which allows a user to upload image data associated with the digital asset request. GUI screen 422 may include a file upload icon 444 which allows a user to upload files associated with the digital asset request. GUI screen 422 may include a submission icon 446 which allows a user to generate and submit a digital asset request based on the information entered and otherwise indicated via the various fields and other graphical user interface objects of GUI screen 422.

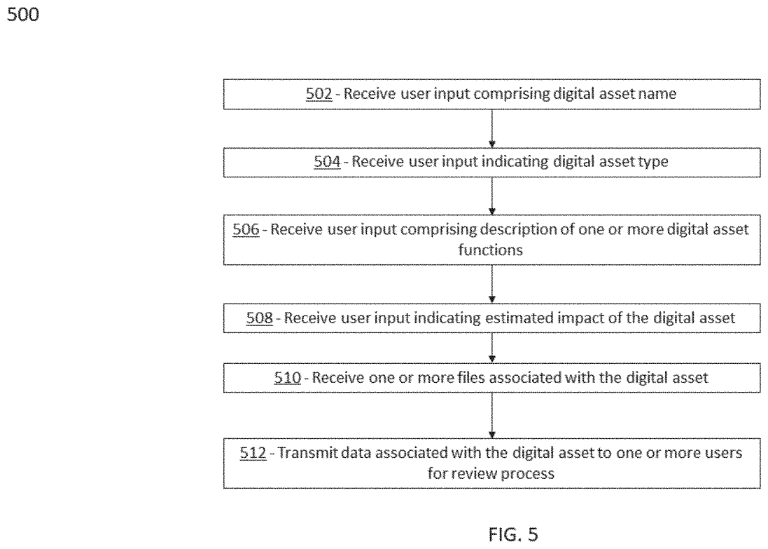

FIG. 5 shows a method 500 for receiving submission a digital asset, according to some embodiments. Method 500 may be executed by one or more processors included in a system (e.g., system 100 of FIG. 1) for upskilling and digital asset management. In some embodiments, all or part of method 500 may be performed as a part of method 200 (e.g., block 212 of method 200). As described below, method 500 may include receipt, by a system (e.g., system 100) of a plurality of user inputs indicating various information about a digital asset being submitted. In some embodiments, any one or more of the various inputs described with reference to method 500 may be executed by a user of a graphical user interface provided by an upskilling and digital asset management system. For example, a user (e.g., creator 132) of a user device may execute one or more of the inputs of method 500 by entering information into fields of a graphical user interface and/or selecting one or more options using graphical user interface menus or affordances.

In some embodiments, submission of a digital asset according to all or part of method 500 may be performed with respect to a specific digital asset request; in some embodiments, submission of a digital asset according to all or part of method 500 may be performed independently without respect to any preexisting digital asset request.

At block 502, in some embodiments, the system may receive a user input indicating a digital asset name. In some embodiments, the input may comprise selection (e.g., from a displayed menu) by a user of a preexisting digital asset request (e.g., an “idea”). In some embodiments, the input may comprise text, e.g. as entered into a graphical user interface field by a user submitting the digital asset. In some embodiments, the user submitting the digital asset may be creator 132 of system 100.

At block 504, in some embodiments, the system may receive a user input indicating a digital asset type for the digital asset. In some embodiments, the input may comprise selection (e.g., from a displayed menu) by a user of a preexisting digital asset request (e.g., an “idea”). In some embodiments, the input may comprise selection (e.g., from a displayed menu) by a user of an asset type from a predefined list of digital asset types. In some embodiments, the input may comprise text, e.g. as entered into a graphical user interface field by a user submitting the digital asset.

At block 506, in some embodiments, the system may receive a user input comprising a description of one or more functions of the digital asset. In some embodiments, the input may comprise selection (e.g., from a displayed menu) by a user of a preexisting digital asset request (e.g., an “idea”). In some embodiments, the input may comprise selection (e.g., from a displayed menu) by a user of an asset function from a predefined list of digital asset functions. In some embodiments, the input may comprise text, e.g. as entered into a graphical user interface field by a user submitting the digital asset.

At block 508, in some embodiments, the system may receive a user input comprising an estimated impact of the digital asset. In some embodiments, the input may comprise selection (e.g., from a displayed menu) by a user of a preexisting digital asset request (e.g., an “idea”). In some embodiments, the input may comprise text, e.g. as entered into a graphical user interface field by a user submitting the digital asset, wherein the text may describe an estimated financial impact and/or an estimate non-financial impact of the digital asset being submitted.

At block 510, in some embodiments, the system may receive a user input comprising one or more files wherein the one or more files may be associated with (e.g., may describe) the digital asset and/or may include code that constitutes the digital asset itself (e.g., wherein the asset may be an automation or bot).

At block 512, in some embodiments, the system may transmit data associated with the digital asset, which may include code constituting all or part of the digital asset itself, for storage and/or distribution to one or more system users. For example, the system may store the submitted digital asset and/or associated metadata in digital asset library 154. The system may, optionally, publish the digital asset such that it may be viewed and downloaded by one or more users of the system. The system may automatically transmit the digital asset to one or more users of the system. In some embodiments, users to whom the digital asset is published and/or transmitted may be automatically selected, as described herein, based on one or more criteria, for example based on role data and/or skill data indicated in user profiles of the associated users. In some embodiments, the system may transmit the digital asset (and/or associated metadata) to one or more users who are eligible or designated to serve as reviewers of the submitted asset (e.g., to review the asset to determine if it can be published or widely distributed amongst system users). In some embodiments, the one or more users reviewing the digital asset data may include an administrative user such as plan administrator 131 of FIG. 1.

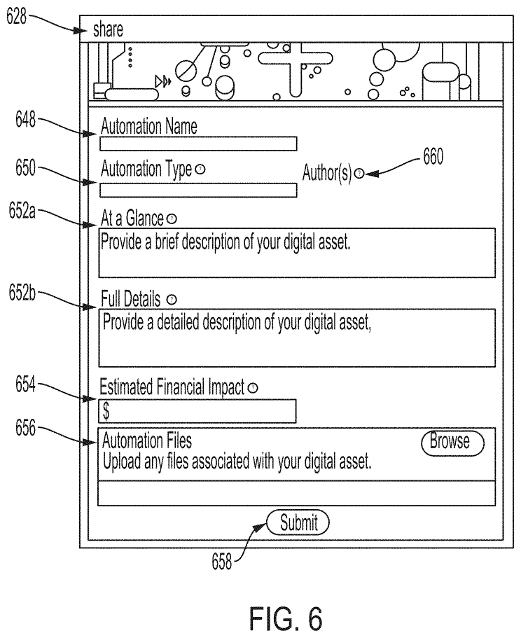

FIG. 6 shows a graphical user interface screen 628 for receiving a digital asset submission, according to some embodiments. In some embodiments, GUI screen 628 may be used by a user of a system to execute all or part of method 500, or to otherwise execute one or more inputs for creating a digital asset request to be transmitted to one or more users of the system. As shown, GUI screen 628 comprises various GUI objects (e.g., fields or icons) configured to receive various user inputs, including digital asset name field 648, digital asset description fields 652a and 652b, and estimated financial impact field 654. Digital asset descriptions fields may include short-form description field 652a (prompting the user to describe the asset “At a Glance”), wherein a user may input a concise description of the asset submission; additionally, description fields may include detailed description field 652b, wherein a user may input a more thorough description of the asset being submitted. GUI screen 628 may comprise digital asset type drop down menu 650, which allows a user select a digital asset type that describes the asset being submitted. GUI screen 628 may include file upload icon 656, which allows a user to upload one or more files associated with (and/or constituting all or part of) the digital asset that they are submitting. GUI screen 628 may include a submission icon 658 which allows a user to cause the asset and associated metadata to be submitted (e.g., transmitted) for review and/or distribution or publication.

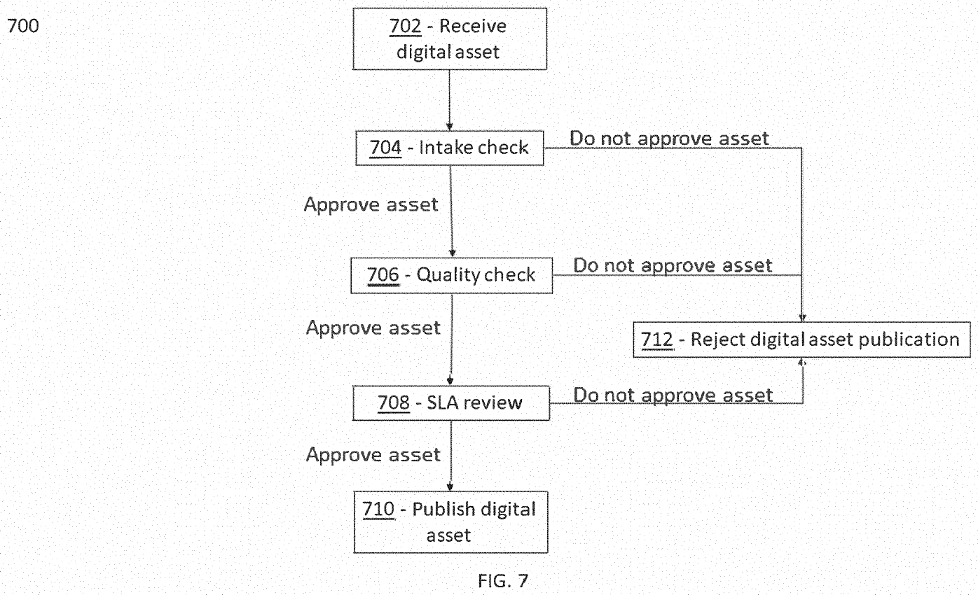

FIG. 7 shows a method 700 for validating a digital asset submission, according to some embodiments.

Method 700 may be executed by one or more processors included in a system (e.g., system 100 of FIG. 1) for upskilling and digital asset management. In some embodiments, all or part of method 700 may be performed as a part of method 200 (e.g., block 214 of method 200). As described below, method 700 may include applying a set of checks to a submitted digital asset, wherein each of the checks comprises determining whether the submitted digital asset meets a set of one or more criteria. The assessments made as part of method 700 may be performed in an automated (e.g., algorithmic) manner and/or in a manual manner based on receipt of a one or more user inputs from a user who is reviewing the submitted digital asset and/or associated data. For example, a user (e.g., plan administrator 131 of FIG. 1) of a user device may execute one or more user inputs indicating whether a submitted digital asset has or has not satisfied one or more criteria for one or more of the checks described with reference to method 700.

At block 702, in some embodiments, a digital asset submission is received by the system. In some embodiments, the digital asset (and, optionally, associated metadata) may be received by one or more processors configured to perform one or more automated validation/approval checks based on the received asset and/or metadata. In some embodiments, the digital asset (and, optionally, associated metadata) may be received by a user device of a user performing one or more validation/approval checks, and information regarding the digital asset (and/or associated metadata) may be rendered on a graphical user interface for review by the user. In some embodiments, a graphical user interface may implement the digital asset in an interactive manner, such that the reviewing user may use the digital asset as part of the review process.

At block 704, the digital asset undergoes an intake check, which determines whether the digital asset (and/or associated metadata) satisfies one or more predefined intake criteria. The assessment as to whether intake criteria are satisfied may be performed algorithmically and/or manually based on user input received from a reviewing user. In some embodiments, performing the intake check may include assessing the quality and completeness of the digital asset. In some embodiments, performing the intake check may include testing one or more functions of the digital asset. In some embodiments, performing the intake check may include providing a risk assessment of the digital asset (e.g., estimating the financial cost of implementing the digital asset). In some embodiments, performing the intake check may include assessing security and/or data privacy risk(s) associated with using the digital asset.

At block 706, in some embodiments, the digital asset undergoes a quality check, which determines whether the digital asset (and/or associated metadata) satisfies one or more predefined quality criteria. The assessment as to whether quality criteria are satisfied may be performed algorithmically and/or manually based on user input received from a reviewing user. In some embodiments, performing the quality check may include assessing the presence, absence, and/or content of one or more errors in the digital asset, and/or may include testing the digital asset for fitness at achieving its intended functionality. In some embodiments, performing the quality check may include assessing (e.g., quantifying and assessing with respect to one or more thresholds) one or more risk affected by (e.g., introduced, increased, and/or ameliorated) by the digital asset. In some embodiments, performing the quality check may include ensuring that the asset is completing work within parameters of a Service Level Agreement (SLA).

At block 708, in some embodiments, the digital asset undergoes a Service Level Agreement (SLA) review (and/or a level-of-service (LOS) review), which determines whether the digital asset (and/or associated metadata) satisfies one or more predefined SLA review criteria. The assessment as to whether LOS review criteria are satisfied may be performed algorithmically and/or manually based on user input received from a reviewing user. In some embodiments, assessing SLA review criteria may include assessing (e.g., quantifying and assessing with respect to one or more thresholds) a manner in which whether the digital asset may impact an organization's infrastructure. In some embodiments, assessing SLA review criteria may include confirming whether the digital asset complies with one or more standards of an organization. In some embodiments, assessing SLA review criteria may include assessing IT and data security risks associated with the digital asset.

In some embodiments, the intake check, quality check, and SLA review may be disposed in series, as shown in FIG. 7. In some embodiments, the depicted checks may be performed in series and/or in parallel with one another and/or with one or more other checks or reviews. In some embodiments, failing one or more checks (or failing more than a threshold number of checks) may cause the system to prevent the digital asset from being distributed or published (e.g., as shown at block 712). In some embodiments, passing all checks (or passing more than a threshold number of checks) may cause the system to distribute or publish the digital asset (e.g., as shown at block 712). In some embodiments, a user performing one or more checks as part of a review process may have options to (via the GUI), approve the asset as passing a given check, reject the asset for failing a given check, send the asset back to a previous check or other review stage, comment on or modify the asset, and/or send the asset back to the creator or to another user for modification.

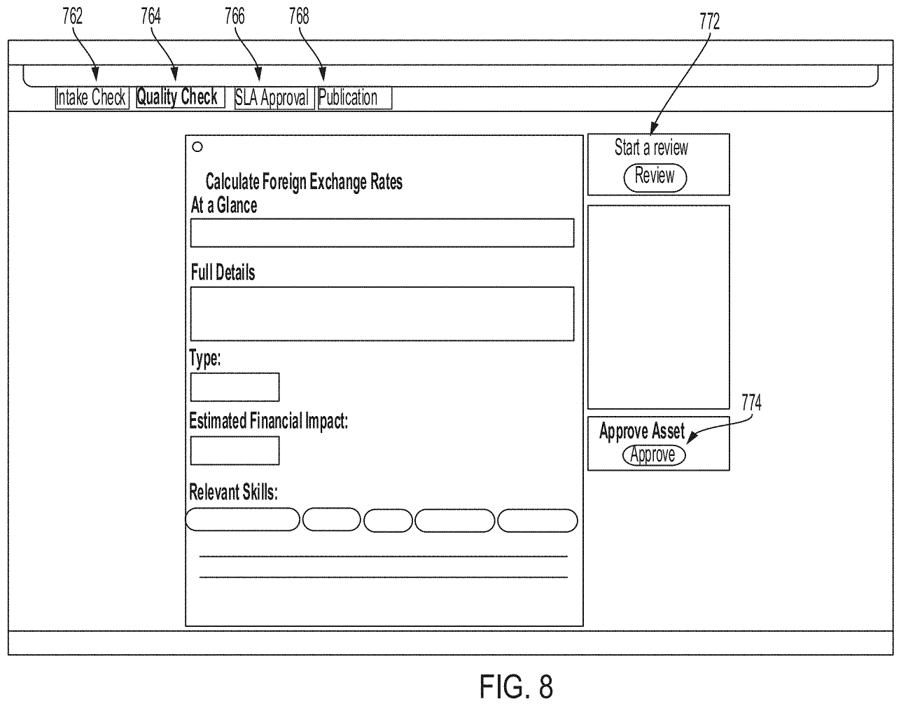

FIG. 8 shows a graphical user interface screen 800 for reviewing and/or validating a digital asset submission, according to some embodiments. In some embodiments, a user may perform one or more of the checks described above with reference to FIG. 7 by using a graphical user interface such as GUI screen 800. In some embodiments, GUI screen 800 may display screens for several review stages that a digital asset may undergo, including: a quality and completeness review; an IT security, data privacy, and/or authentication review; and a final executive review wherein the asset may receive approval for publication to a desired audience. As shown, GUI screen 800 may comprise several tabs which allow a user to toggle between various review stages. In some embodiments, such tabs may include an intake check tab 762, a quality check tab 764, an SLA approval tab 766, and a publication tab 768. Selection (e.g., by clicking or tapping) of one of these tabs may cause the system to display a corresponding GUI screen that shows information and GUI affordances for performing the corresponding review stage. In the example shown in FIG. 8. In the example shown in FIG. 8, quality check tab 764 is selected, which has caused the GUI to display information for performing a quality check, including information about the submitted asset including a title (“Calculate Foreign Exchange Rates”), an “at a glance” summary, a “full details” summary, an asset type, an estimated financial impact, and relevant skills associated with the asset. In some embodiments, this summary information may be represented textually and/or graphically. In some embodiments, GUI screen 800 may include a review icon 772, which allows users to initiate a given review stage. In some embodiments, GUI screen 800 may include an approval icon 774, which allows users to approve a digital asset at a given review stage.

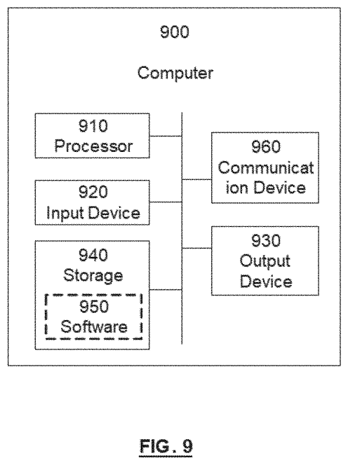

FIG. 9 shows a computer, in accordance with some embodiments. Computer 900 can be a component of an upskilling and digital asset management system according to the systems and methods described above, such as system 100 of FIG. 1. In some embodiments, computer 900 may execute a one or more of the methods described herein, such as a method for managing digital assets.

Computer 900 can be a host computer connected to a network. Computer 900 can be a client computer or a server. As shown in FIG. 9, computer 900 can be any suitable type of microprocessor-based device, such as a personal computer, workstation, server, or handheld computing device, such as a phone or tablet. The computer can include, for example, one or more of processor 910, input device 920, output device 930, storage 940, and communication device 960. Input device 920 and output device 930 can correspond to those described above and can either be connectable or integrated with the computer.

Input device 920 can be any suitable device that provides input, such as a touch screen or monitor, keyboard, mouse, or voice-recognition device. Output device 930 can be any suitable device that provides an output, such as a touch screen, monitor, printer, disk drive, or speaker.

Storage 940 can be any suitable device that provides storage, such as an electrical, magnetic, or optical memory, including a random access memory (RAM), cache, hard drive, CD-ROM drive, tape drive, or removable storage disk. Communication device 960 can include any suitable device capable of transmitting and receiving signals over a network, such as a network interface chip or card. The components of the computer can be connected in any suitable manner, such as via a physical bus or wirelessly. Storage 940 can be a non-transitory computer-readable storage medium comprising one or more programs, which, when executed by one or more processors, such as processor 910, cause the one or more processors to execute methods described herein.

Software 950, which can be stored in storage 940 and executed by processor 910, can include, for example, the programming that embodies the functionality of the present disclosure (e.g., as embodied in the systems, computers, servers, and/or devices as described above). In some embodiments, software 950 can include a combination of servers such as application servers and database servers.

Software 950 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 940, that can contain or store programming for use by or in connection with an instruction execution system, apparatus, or device.

Software 950 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 900 can implement any operating system suitable for operating on the network. Software 950 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A system for transmitting digital assets amongst a plurality of users, the system comprising one or more processors configured to cause the system to:
generate and store a plurality of user profiles for a plurality of users of the system, wherein the user profiles indicate respective skill sets for the respective users;
cause display of a graphical user interface configured to accept instructions regarding digital asset requests,
receive, via the graphical user interface, a first input instructing a digital asset request and indicating one or more skills associated with the digital asset request; and
in response to receiving the first input:
determine a set users of the plurality of users of the system whose respective skill sets include the one or more skills associated with the digital asset request; and
transmit, to respective user devices associated with the set of users, an indication of the digital asset request.

2. The system of claim 1, wherein the digital asset comprises executable program code.

3. The system of claim 1, wherein the indication of the digital asset request indicates a plurality of requirements for fulfilling the digital asset request and indicates the one or more skills associated with the digital asset request.

4. The system of claim 1, wherein the input indicating the one or more skills associated with the digital asset request indicates:
a preexisting skill of a user that is required for the user to be able to respond to the request; and
an amount by which a skill level associated with the preexisting skill will be increased by for a user who fulfills the digital asset request.

5. The system of claim 4, wherein the one or more processors are further configured to cause the system to:
receive, from a first user of the set of users, a digital asset responsive to the digital asset request;
in accordance with receipt of the digital asset, update a user profile of the first user to update the skill level for the first user.

6. The system of claim 5, wherein the one or more processors are further configured to cause the system to transmit the digital asset to a set of users of the system different from the first user.

7. The system of claim 6, wherein the one or more processors are further configured to cause the system to receive digital asset feedback for the digital asset from one or more of the set of users of the system, wherein the digital asset feedback comprises one or more feedback types selected from: a modified version of the digital asset, an expansion of the digital asset, a sponsorship of the digital asset, a comment on the digital asset, and a like of the digital asset.

8. The system of claim 1, wherein the system is configured to cause display of a pipeline interface for interacting with digital assets that have been uploaded by users, wherein the pipeline interface provides interface screens for one or more of: a digital asset dashboard, a digital asset intake check, a digital asset quality check, a digital asset level of service review, and available digital assets.

9. A method for transmitting digital assets amongst a plurality of users, the method performed at a system comprising one or more processors, the method comprising:
generating and store a plurality of user profiles for a plurality of users of the system, wherein the user profiles indicate respective skill sets for the respective users;
causing display of a graphical user interface configured to accept instructions regarding digital asset requests,
receiving, via the graphical user interface, a first input instructing a digital asset request and indicating one or more skills associated with the digital asset request; and
in response to receiving the first input:
determining a set users of the plurality of users of the system whose respective skill sets include the one or more skills associated with the digital asset request; and
transmitting, to respective user devices associated with the set of users, an indication of the digital asset request.

10. A non-transitory computer-readable medium storing instructions for transmitting digital assets amongst a plurality of users, wherein the instructions are executable by a system comprising one or more processors to cause the system to:
generate and store a plurality of user profiles for a plurality of users of the system, wherein the user profiles indicate respective skill sets for the respective users;
cause display of a graphical user interface configured to accept instructions regarding digital asset requests,
receive, via the graphical user interface, a first input instructing a digital asset request and indicating one or more skills associated with the digital asset request; and
in response to receiving the first input:
determine a set users of the plurality of users of the system whose respective skill sets include the one or more skills associated with the digital asset request; and
transmit, to respective user devices associated with the set of users, an indication of the digital asset request.
